(19) United States
(12) Patent Application Publication
(10) Pub. No.: US 2015/0320093 A1
(43) Pub. Date: Nov. 12, 2015

(54) PROCESSED KONJAC FOOD OR DRINK HAVING BLOOD GLUCOSE INCREASE SUPPRESSING EFFECT

(71) Applicants: Masaaki Tokuda, Kiga-gun (JP); Koji Murao, Kiga-gun (JP); Noritsugu Hishitani, Kiga-gun (JP)

(72) Inventors: Masaaki Tokuda, Kiga-gun (JP); Koji Murao, Kiga-gun (JP); Noritsugu Hishitani, Kiga-gun (JP)

(73) Assignees: NATIONAL UNIVERSITY CORPORATION KAGAWA UNIVERSITY, Takamatsu-shi, Kagawa (JP); HAISKY FOODS CORPORATION, Kita-gun, kagawa (JP); NATIONAL UNIVERSITY CORPORATION KAGAWA UNIVERSITY, Takamatsu-shi, Kagawa (JP); HAISKY FOODS CORPORATION, Kita-gun, kagawa (JP)

(21) Appl. No.: 14/345,479

(22) PCT Filed: Jan. 31, 2014
(86) PCT No.: PCT/JP2014/052233

§ 371 Date: Mar. 18, 2014

(30) Foreign Application Priority Data
Jan. 31, 2013 (JP) 2013-017033
Oct. 25, 2013 (JP) 2013-221868

(51) Int. Cl. A23L 1/214; A23L 1/09; A23L 2/52; A23L 1/30; A23L 2/02

(52) U.S. Cl. CPC A23L 1/2147; A23L 1/3002; A23L 1/30; A23L 2/02; A23L 2/52; A23L 1/09; A23V 2002/00

(57) ABSTRACT

A processed konjac food having blood glucose increase suppressing effect is provided. The processed konjac food having blood glucose increase suppressing effect contains a konjac having a pH in a range of 2.5 to 7.4 and a rare sugar as active ingredients, is intended for ingestion of the rare sugar at a daily dose of 0.3 to 50 g/day for suppressing blood glucose increase, and is shaped into a rectangular, thread, round, grain, or plate form. The blood glucose increase effect can last for at least one day after one-time ingestion. For example, by making a konjac containing a rare sugar into a processed food, the product can be adapted to any consumer preferences without impediment upon eating or drinking, and therefore, a long-term ingestion is facilitated and the blood glucose increase suppressing effect can be sustained for a long period.

### TECHNICAL FIELD

The present invention relates to a processed konjac food or drink having blood glucose increase suppressing effect, and preferably to a smoothie-like food or drink having blood glucose increase suppressing effect containing fine grain konjac and a rare sugar. The invention provides a new functional food having a fulfilling functionality by combining konjac which is a characteristic bioactive substance with a rare sugar, thereby promoting health improvement.

### BACKGROUND ART

There are a large number of diabetics or people who are strongly suspected of suffering diabetes, and people said to be obese in Japan. Those diseases are called “metabolic syndromes” and, among the metabolic syndromes, are associated strongly with cerebrovascular disorder and considered as risk factors. In particular, hyperglycemia, hyperlipidemia and hyperuricemia that do not emerge as abnormal laboratory values or as symptoms are especially dangerous and prompt countermeasures therefor are required. For the purpose of prevention of those diseases, a variety of health foods including foods for specified health uses have been increasingly demanded, and physiological functions of foods have attracted renewed attention. In particular, dietary fiber has been known to have physiological activity, mainly including an intestine regulating function and postprandial blood glucose increase suppressing effect, and has been utilized as a material for enhancing a function of a food. In addition, rare sugars and the like have attracted attention as a substance that has a physiological action and when added to a food, does not inhibit a function of the food, such as taste, texture, and flavor. Among the rare sugars, D-psicose has particularly been reported on its low calorie content, effects of blood glucose level improvement and arteriosclerosis improvement, and the like, therefore being expected as a lifestyle-related disease prevention material and a biological function improving agent. However, there are only a few reports on biological functions in case of combining these food materials.

For the purpose of improving biological functions by the dietary fiber, many techniques have been disclosed. For example, Patent Document 1 proposes Jerusalem artichoke konjac which is versatile in terms of cooking and is expected to have action of suppressing blood glucose increase, in which the blood glucose increase suppressing action is owing to synergistic effect obtained by adding inulin of rare Jerusalem artichoke which is said to be a natural insulin to refined powder of konjac rich in glucomannan dietary fiber, on the premise of the effect of improvement and prevention of diabetes and lifestyle-related diseases. Patent Document 2 proposes nutritional supplementary foods, characterized in that concentrate of coconut juice and/or coconut powder is blended with dry konjac. Patent Document 3 proposes a method for producing a konjac jelly, comprising dissolving glucomannan in water, charging the obtained solution in a container, and gelating the solution in the container, characterized in that okara (tofu refuse) is dissolved in water together with the glucomannan. Patent Document 4 proposes a method for producing a konjac product, characterized by comprising: dissolving konjac glucomannan in water to form sol; adding a polysaccharide thickener and other additives to the solated aqueous konjac glucomannan solution and stirring the mixture for mixing; and cooling the mixture of the solated konjac glucomannan with the polysaccharide thickener and additives to form gel, wherein the konjac product is to be solated in a body after eating.

On the other hand, rare sugars are one kind of sugars which have received attention in recent years, can be used also as a sweetener, and has a physiological action. Rare sugars have been reported on its low calorie content, effects of blood glucose level improvement and arteriosclerosis improvement, and the like, and thus have been expected as a lifestyle-related diseases prevention material or a biological function improving agent.

For example, Patent Documents 5 and 6 propose a composition of carbohydrates and/or sugars containing D-psicose and/or its derivatives, by which a rapid increase of a blood glucose level after ingestion can be suppressed more than in single ingestion of the carbohydrates and/or the sugars. Patent Document 7 proposes a composition containing D-allose and suppressing a rapid blood glucose increase when ingesting carbohydrates and/or sugars, as a composition having an effect of suppressing a rapid blood glucose increase upon ingestion of carbohydrates and/or sugars. Patent Document 8 proposes a composition for improving a function, such as a liver function and a function relating blood glucose level, serum lipid value, body weight increase and visceral fat accumulation, the composition containing dietary fiber and a rare sugar as active ingredients, wherein the composition contains 1% by weight or more of the dietary fiber and 2% by weight or more of the rare sugar and/or a derivative thereof, based on the total composition, D-psicose and/or a derivative thereof is used as the rare sugar, and indigestible dextrin which is a water soluble dietary fiber is used as the dietary fiber.

### CITATION LIST

### Patent Documents

### Patent Document 1: JP-A-2011-130776

### Patent Document 2: JP-A-2008-237058

### Patent Document 3: JP-A-2002-204662

### Patent Document 4: JP-A-08-131096

### Patent Document 5: JP-A-2005-213227

### Patent Document 6: WO2006/101118

### Patent Document 7: JP-B-5116072

### Patent Document 8: JP-A-2010-18528

### Patent Document 9: Japanese Patent Application No. 2013-17033

### Patent Document 10: WO2008/142860

### Patent Document 11: JP-B-3829211

### Patent Document 12: JP-B-3840511

### Patent Document 13: JP-B-3905830

### Patent Document 14: JP-B-4822541

### Patent Document 15: JP-A-2008-289408

### SUMMARY OF THE INVENTION

### Problems that the Invention is to Solve

Number of diabetics in Japan is currently said to be 8 million, and when including the border region, it is said to be 22 million. Konjac mannan (konjac) has been conventionally expected to be a food capable of lowering blood glucose level. For example, Patent Document 2 concludes that, in a nutritional supplementary food, nutrient balance is ensured even with a low calorie content, on the basis of the fact that a significant increase of intracerebral acetylcholine was confirmed in mice daily given a nutritional supplementary food of konjac mannan mixed in feed, and further reports on its effects of lowering blood glucose level, exerting hypotensive action, and giving a feeling of fullness. Patent Document 4 concludes that, on the basis of data obtained from one subject given the konjac product for two month, the konjac mannan is converted to a large amount of water soluble dietary fiber having viscosity which then acts in the body to perform functions, such as suppression of blood cholesterol and blood glucose increases. However, the document does not disclose any clinical study data that supports that the konjac is a food capable of lowering blood glucose level.

In addition, in order to take the konjac mannan together with the other physiological active ingredients, the both powders have been mixed to obtain a product of powder form, and optionally form the mixed powder into a shaped product by utilizing the gelation act of the konjac mannan. In such a case, complex works are often required for shaping the konjac mannan into a form that can be taken as a biological function improving food.

Furthermore, it has been proposed to make the konjac mannan into a jelly product or to add it to a cake or the like in order to produce a food having a form that can be easily and favorably taken by anyone, but such products have not been sufficient as a food that can be readily taken continually for a long period.

On the other hand, it is known that rare sugars have an action of lowering blood glucose level and are to be taken together with dietary fibers, but only indigestible dextrin is known specifically as the dietary fibers and no improvement has currently been proposed for easy ingestion thereof in a form of final commercial product.

D-psicose pure material which is one of the rare sugars is now in the course of application for approval as a food for specified health uses based on its blood glucose increase suppressing effect. Although artificial zero-calorie sweeteners generally have been inferior in taste, D-psicose is a natural sweetener having a good taste, zero calorie content, and functionality. Accordingly, if D-psicose can be readily used as a sweetener for diabetics, it may be delightful news for diabetics, thereby contributing to the solution of social issues.

The present inventors have conducted an extensive studies to find out a food form capable of sustaining the action continuously for a long period by combining konjac (konjac mannan), among other dietary fibers which are ingredients having blood glucose reduction effect, with a rare sugar. As a result, they found out that a combination of dealkalized konjac (neutralized konjac, a konjac having a pH in the range of 2.5 to 7.4) with a rare sugar was promising. Blood glucose level of a healthy human reaches the maximum value in about 15 minutes in artery, and in about 30 minutes in vein, after ingestion of starch or sucrose, and gradually gets back to a normal level. The invention has an object to provide a processed konjac food or drink comprising konjac that is usually eaten and a rare sugar contained in the konjac, which suppresses an abnormal increase of plasma glucose level only by eating. The invention has an object to provide a processed konjac food or drink having blood glucose increase suppressing effect, characterized in that the processed konjac food or drink is in various forms comprising a dealkalized konjac and a rare sugar in a combination.

More specifically, the invention has an object to provide a rare sugar-containing shaped konjac product, such as a smoothie-like food, a salad konjac, tuna slice-like konjac for use in a seasoned tuna rice bowl, and caviar-like konjac, containing a dealkalized konjac and a rare sugar.

### Means for Solving the Problems

A subject matter of the invention is a processed konjac food or drink having blood glucose increase suppressing effect, set forth in the following (1) to (12).

(1) A processed konjac food or drink having blood glucose increase suppressing effect, comprising a konjac having a pH in the range of 2.5 to 7.4 and a rare sugar, as active ingredients.

(2) The processed konjac food or drink having blood glucose increase suppressing effect according to the above (1), wherein the rare sugar is D-psicose and/or D-allose.

(3) The processed konjac food or drink having blood glucose increase suppressing effect according to the above (2), wherein the D-psicose is D-psicose and/or a derivative thereof, and the derivative of D-psicose is selected from a sugar alcohol obtained by converting a ketone group in D-psicose into an alcohol group, an uronic acid obtained by oxidizing an alcohol group in D-psicose, and an amino sugar obtained by replacing an alcohol group in D-psicose with an NH2 group.

(4) The processed konjac food or drink having blood glucose increase suppressing effect according to the above (2) or (3), wherein the D-allose is D-allose and/or a derivative thereof, and the derivative of D-allose is selected from a sugar alcohol obtained by converting an aldehyde group in D-allose into an alcohol group, an uronic acid obtained by oxidizing an alcohol group in D-allose, and an amino sugar obtained by replacing an alcohol group in D-allose with an NH2 group.

(5) The processed konjac food or drink having blood glucose increase suppressing effect according to any one of the above (1) to (4), wherein the konjac having a pH in the range of 2.5 to 7.4 is a fine grain konjac having a grain size of 0.1 to 3.0 mm.

(6) The processed konjac food or drink having blood glucose increase suppressing effect according to any one of the above (1) to (5), wherein the processed konjac food or drink is a smoothie-like food or drink.

(7) The processed konjac food or drink having blood glucose increase suppressing effect according to the above (5) or (6), wherein the fine grain konjac is produced by mixing the grains with an acidic material in an amount at least capable of neutralizing an alkali content contained in the grains, and heat-treating the mixture.

(8) The processed konjac food or drink having blood glucose increase suppressing effect according to the above (7), wherein the acidic material contains at least one selected from a seasoning, a thickening substance, a fruit juice, a puree obtained by crushing and straining a fruit and/or a vegetable, a fruit paste, and a vegetable paste.

(9) The processed konjac food or drink having blood glucose increase suppressing effect according to the above (7) or (8), wherein the acidic material contains at least one acidulant selected form gluconic acid, citric acid, and lactic acid, for neutralizing the alkali content.

(10) The processed konjac food or drink having blood glucose increase suppressing effect according to any one of the above (1) to (9), which is intended for ingestion of the rare sugar, at a daily dose of 0.3 to 50 g/day, together with the konjac, for suppressing blood glucose increase.

(11) The processed konjac food or drink having blood glucose increase suppressing effect according to any one of the above (1) to (10), which is intended for ingestion of a daily dose of the rare sugar together with the konjac, in a form containing 40 to 95% by weight of the konjac and 0.1 to 10.0% by weight of the rare sugar, based on the whole food or drink.

(12) The processed konjac food or drink having blood glucose increase suppressing effect according to any one of the above (1) to (11), which is intended for ingestion of a daily dose of the rare sugar, in at least once a day, together with the konjac.

Another subject matter of the present invention is a food or drink in container which contains a processed konjac food or drink having blood glucose increase suppressing effect, set forth in the following (13) and (14).

(13) A food or drink in container, which contains the processed konjac food or drink having blood glucose increase suppressing effect as set forth in any one of the above (1) to (12).

(14) The food or drink in container according to the above (13), which contains, in one container, the rare sugar in an amount of 0.3 to 50 g which is an intake required for one day, together with the konjac.

Moreover, another subject matter of the invention is a method for suppressing blood glucose increase, set forth in the following (15) and (16).

(15) A method for suppressing blood glucose increase, characterized by comprising a step of ingesting the processed konjac food or drink having blood glucose increase suppressing effect as set forth in any one of the above (1) to (12).

(16) The method for suppressing blood glucose increase according to the above (15), wherein a step of ingesting D-psicose is provided at every meal.

### Advantage of the Invention

The present invention has the following effects. The processed konjac food or drink of the invention has an action of suppressing abnormal increase of plasma glucose level which can not be predicted by a single component, by combining a neutralized konjac with a rare sugar, and is capable of newly providing a food or drink for improving biological functions useful for prevention and treatment of diabetics. The processed konjac food or drink of the invention comprising a neutralized konjac combined with a rare sugar can be provided in various forms.

The smoothie-like food or drink of the invention can be taken without any difficulty by anyone owing to an action of fine konjac grains. Furthermore, the smoothie-like food is easily given variety in taste, flavor, etc., thereby not making an eater or drinker get tired. Generally, continual ingestion for a long period is required for a health food to exert its effects, and the processed konjac food or drink of the invention comprising a dealkalized konjac combined with a rare sugar, in particular, the smoothie-like food or drink is suitable for such ingestion over a long period.

More particularly, the processed konjac food or drink of the invention has the following effects. (1) The processed konjac food or drink comprising a konjac combined with a rare sugar can exert a blood glucose increase suppressing effect. (2) The blood glucose increase suppressing effect is sustained for about one day after ingestion. (3) The processed konjac food or drink comprising a konjac combined with a rare sugar can respond to diverse preferences, since it can be varied in flavor, texture, etc. relatively freely. (4) The processed konjac food or drink enables continual ingestion for a long period without making eaters or drinkers tired since it can be adapted to a preference of each eater or drinker. (5) The processed konjac food or drink is useful for prevention or treatment of diseases caused by blood glucose increase, in diabetics or other patients.

Examples of the processed konjac food of the invention include a product obtained by shaping a konjac containing a rare sugar, into plates or grains, such as a salad konjac, tuna slice-like konjac for use in a seasoned tuna rice bowl, and caviar-like konjac. To these shaped konjac products, a taste or texture according to their use can be imparted, and the shaped konjac products can exert the above-mentioned physiological effect.

### BRIEF DESCRIPTION OF THE DRAWINGS

FIG. 1 shows test results which demonstrate a blood glucose increase suppressing effect by a smoothie-like food or drink containing a fine grain konjac and a rare sugar.

FIG. 2 shows the test results in FIG. 1 after correction into 0-minute value.

FIG. 3 shows test results which demonstrate a blood glucose increase suppressing effect by a smoothie-like food or drink containing a fine grain konjac and a rare sugar-containing syrup.

FIG. 4 shows the test results in FIG. 3 after correction into 0-minute value.

FIG. 5 shows an appearance of a container containing salad konjac pieces having different hues.

FIG. 6 shows an appearance of a container containing konjac for seasoned tuna rice bowl.

FIG. 7 shows a cross-sectional shape of the konjac for seasoned tuna rice bowl.

FIG. 8 shows an appearance of a container containing caviar-like konjac grains.

FIG. 9 shows an appearance of octopus-like konjac.

FIG. 10 shows an appearance of Squid Mentaiko-like konjac (Mentaiko; Japanese spicy cod roe, Squid Mentaiko; squid pieces mixed with Mentaiko grains).

FIG. 11 shows an appearance of smoked salmon-like konjac.

FIG. 12 shows an appearance of Liver sashimi-like konjac (sashimi; slice of raw material).

FIG. 13 shows an appearance of Chinese jellyfish-like konjac.

### MODE FOR CARRYING OUT THE INVENTION

D-Psicose, which is a rare sugar, is contained in foods, and is a sugar having eating experience. D-psicose is non-enzymatically produced from D-fructose by heating during food processing. Since psicose is easily produced by high temperature, high pH, high fructose concentration, and heating for a long time, during processing, it is suggested that about 0.2 g of D-psicose may be ingested per day. Ina food containing a rare sugar such as D-psicose, under a low pH, since, for example, a transfer reaction between D-psicose and D-fructose is suppressed, a loss amount of the rare sugar can be suppressed. This invention is characterized by combining konjac with the rare sugar having such a nature.

The invention relates to a processed konjac food or drink, preferably a processed konjac food shaped into a rectangular, thread, round, grain, or plate form, which suppresses a loss amount of the rare sugar due to that pH of the konjac material in contact with the rare sugar is adjusted into a range of 2.5 to 7.4, and has an effect of synergistically suppressing blood glucose increase, in all kinds and forms of foods, drinks, and food materials containing konjac material and a rare sugar. Preferably, the present invention relates to a smoothie-like food or drink having blood glucose increase suppressing effect, characterized by containing a fine grain konjac and a rare sugar, and can provide a smoothie-like food or drink having a better physiological activity compared to that shown by the konjac or the rare sugar alone.

In the invention, since the processed food or drink contains, as active ingredients, a combination of konjac having a pH in a range of 2.5 to 7.4 and a rare sugar, pH of the processed konjac food or drink is adjusted to a low level, and as a result, the rare sugar is stably maintained to suppress the loss amount. Accordingly, the invention can provide a processed konjac food or drink having blood glucose increase suppressing effect, which is intended for ingestion of a rare sugar at a daily dose of 0.3 to 50 g/day, for suppressing blood glucose increase. Additionally, the processed food or drink can exert a better physiological activity than that shown by the konjac or the rare sugar alone. The better physiological action was supported by a smoothie-like food or drink having blood glucose increase suppressing effect characterized by containing a fine grain konjac (pH 3.7) and a rare sugar (Examples), and based on this result, it was found that processed konjac foods or drinks other than the smoothie-like food or drink can also exert a better physiological activity than that shown by the konjac or the rare sugar alone. The invention was thus completed.

The processed konjac food or drink of the invention relates to an excellent drink or food which can prevent lifestyle-related diseases such as diabetes. Since the processed konjac food or drink of the invention has no impediment for eating and can be given various flavors or tastes, this food or drink facilitates continual ingestion of konjac and a rare sugar for a long period, and is useful for prevention and treatment of lifestyle-related diseases.

In addition, as the processed food of the invention, the konjac containing a rare sugar can be used after shaping into a plate or grain form. Examples of the processed food include a plate or grain shaped konjac product to be added to a vegetable salad, a tuna slice-like shaped konjac product to be used in, for example, a seasoned tuna rice bowl, a caviar-like grain shaped konjac product, or the like.

“Glucomannan”, “konjac mannan”, and “konjac” are herein used as synonyms in the description of the invention. The invention can obtain a given effect by using a substance included in these words.

The processed konjac food according to the present invention is intended for all kinds and forms of food, drink, and food material made of konjac material, and characterized in that the konjac material in contact with a rare sugar is adjusted into the range of 2.5 to 7.4. For example, a colored and uncolored product of a rectangular, thread, round, grain, and plate shape are included. Specifically, examples thereof include a salad konjac in which a single color of or two or more color combination of colored konjac pieces containing a rare sugar shaped into a certain shape are packaged, a tuna slice-like konjac to be used for seasoned tuna rice bowl which is obtained by soaking a konjac in a seasoning liquid containing a rare sugar to impregnate the konjac with a rare sugar and has a pH in the range of 2.5 to 7.4, a caviar-like konjac containing a rare sugar and having a pH in the range of 2.5 to 7.4.

Although a smoothie-like food or drink whose good physiological activity as a processed konjac food or drink was supported in the invention is described herein as an example, the content of a rare sugar related to the processed konjac food or drink, the amount of a rare sugar to be ingested, the blood glucose increase suppressing effect, the process for neutralization of konjac, the condition of heating, and the other materials used for the production are applied in common to other processed konjac foods or drinks according to the invention.

### [Smoothie-Like Food or Drink]

Smoothie is a concentrated fruit drink containing a crushed whole fresh fruit, which conventionally has been popular among young people. The smoothie-like food or drink of the invention is a smoothie-like viscous fruity seasoned paste that is made of fine grain konjac, a concentrated fruit juice, a thickener, a ground or crushed material of a fruit, and other seasonings such that a new form of smoothie is produced using the fine grain konjac.

The smoothie-like food or drink can be eaten with a spoon after mixing with an equal amount of water or milk, or drunk through straw after diluting, as an diet food, and can be formed into a frozen type. The smoothie-like food or drink has a good taste, is visually fine, gives a fruity feeling, and in particular provides a feeling of fullness for a long time, and therefore, it gives an excellent effect in any function. The smoothie-like food or drink can thus be used also as a processed konjac product that is useful for diet.

For example, the smoothie of the invention is produced by mixing sugars, a concentrated fruit juice, a thickener, a ground or crushed material of a fruit, and other seasonings into a fine grain konjac and heating the mixture. A variety of smoothies, such as blueberry-, strawberry-, and apple-flavored one, can be produced by using concentrated fruit juices or various flavors. In addition, the food texture, such as feeling on tongue, can be changed by adjusting the grain size of the fine grain konjac or the addition amount thereof. The smoothie-like food or drink of the invention contains a neutralized or unneutralized fine grain konjac and a rare sugar.

### [Contents of Fine Grain Konjac and Rare Sugar]

The fine grain konjac contained in the smoothie-like food or drink of the invention is preferably a neutralized fine grain konjac, and is preferably contained in the food or drink, in an amount such that a texture similar to that of the crushed fruit in the existing smoothie is imparted and the blood glucose reduction effect can be exerted, preferably, in a proportion of 40 to 95% by weight of the whole food or drink. When the fine grain konjac is contained in an amount higher than the upper limit, the smoothie's natural viscosity and texture may be lost, while when contained in an amount less than the lower limit, the smoothie's natural properties may not be exerted, and in addition, the effect of the blood glucose reduction may be deteriorated. More preferably, an amount in the range of 50 to 85% by weight is effective for exerting the texture as a smoothie and the blood glucose reduction effect.

When the fine grain konjac has a grain size of 0.1 to 3.0 mm, the texture as smoothie and the blood glucose reduction effect can be imparted. When the grain size is larger than the upper limit, the texture such as feeling on tongue or throat may be deteriorated and the food may become no longer a smoothie, and further become difficult to drink. When the grain size is smaller than the lower limit, the drink may become a thin liquid like a juice or milk. More preferably, the fine grain konjac has a grain size of 0.1 to 2.0 mm.

The rare sugar is, for example, D-psicose or D-allose. The content of the rare sugar in the smoothie-like food or drink is preferably in the range of 0.1 to 50.0% by weight. When the content is higher than the upper limit, further enhancement of the blood glucose increase suppressing effect can not be expected and also such a case may not be economically preferable. A more preferred content of the rare sugar is in the range of 0.1 to 10.0% by weight.

### [Intake of Rare Sugar]

D-allose and/or its derivative, and/or D-psicose and/or its derivative is preferably ingested by an adult in a dose of 0.3 to 50 g as D-psicose per day in case of oral administration, and the dose may be increased or decreased depending on the age and the symptom. When the rare sugar is ingested in a form of a combination with konjac, the blood glucose increase suppressing effect may be sustained for at least one day after the ingestion. The daily dose of the rare sugar is ingested in a form of a combination with konjac, once a day, or by dividing the daily dose into two or three times in a day at adequate intervals.

### [Examples of Blood Glucose Increase Suppressing Effect of Smoothie-Like Food or Drink of the Invention]

A test is performed for demonstrating the blood glucose increase suppressing effect of the smoothie-like food or drink of the invention. Five kinds of samples were provided and seven healthy persons drank these samples, followed by drinking glucose, and the blood glucose levels were measured at time points after 30 min, 60 min, and 120 min.

(A) Fasting glucose tolerance test

(B) Sample containing rare sugar

(C) Sample containing fine grain konjac and rare sugar

(D) Sample containing a large amount of fine grain konjac

(E) Sample containing a small amount of fine grain konjac

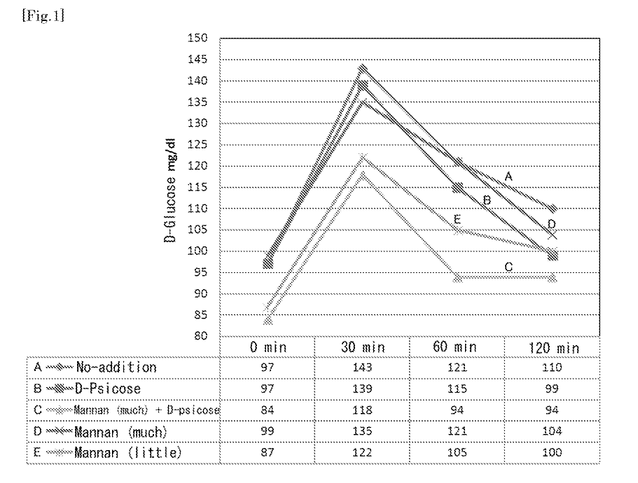

The mean values of the measurement data were calculated. The results are shown in FIG. 1. It was found from the test results shown in FIG. 1 that the blood glucose increase in the glucose tolerance test was suppressed by drinking konjac, and furthermore, a better blood glucose increase suppressing effect which could not be obtained by the konjac or the rare sugar alone could be obtained by drinking the konjac and the rare sugar at the same time. That is, the smoothie-like food or drink containing the fine grain konjac and a rare sugar was demonstrated to have an excellent blood glucose increase suppressing effect.

The invention relates to a food or drink and health food or drink for a human who needs prevention and treatment of diseases which require to save poor insulin, improve insulin sensitivity, and correct the high blood glucose, and diseases in which the symptom is improved or the onset is prevented by suppression of abnormal increase in a day of plasma glucose level (blood glucose level), such as diabetes, latent diabetic condition, obesity, hyperlipidemia, and arteriosclerosis. The food or drink and health food or drink of the invention is characterized by containing a neutralized processed konjac food and a rare sugar and/or its derivative as active ingredients thereof.

### [Production of Fine Grain Konjac]

A shaped product produced by an ordinary method can be used to manufacture the fine grain konjac. The shaped product can be manufactured, for example, by grinding or crushing an ordinary thread-like or plate-like alkaline konjac (pH 12.0) obtained by mixing konjac powder with water or warm water and stirring the mixture into paste, and gelating the paste with an alkali (calcium hydroxide). The concentration of the konjac powder is about 2 to 4%, and at this time, tapioca starch or the like may be added for the purpose of, in particular, improving the physical properties, a colorant of, for example, yellow, red and green, may be added to color the shaped product, or a dealkalized konjac may be used.

The gelated shaped product is preferably miniaturized using a crusher such as a hammer mill and a flush mill, followed by further miniaturization with high pressure homogenizer. Alternatively, similar to the case of shaping Shirataki (noodles made from konjac) or thread konjac using a perforated plate having many apertures for shaping, the gel product may be extruded as 15 to 60 threads at one time from a perforated plate provided at a discharge port of a kneading apparatus into a warm water bath, and solidified by aging, followed by crushing the resulting threads into fine pieces using a crusher. The surface condition or the like of the product are varied depending on the production process of the fine grain konjac.

### [Length or Grain Size of Fine Grain Konjac]

The length and grain size of the fine grain konjac may be appropriately selected according to the application thereof, and the fine grain product of 3 mm or less, preferably in the range of 0.1 mm to 2.0 mm may be used. The shape thereof includes a cylindrical, rectangular column, plate, and spherical shape, and a grain shape having irregularity on the surface. Since a grain size of a ground product that does not give grain feelings in a mixture with a food may be about 90 μm or less, a grain size of 100 μm or more is preferred. Various sizes of the ground particles may be produced depending on the degree of the grinding processing, but the grain size can be determined by selecting a operation time of the crusher.

### [Neutralization Step of Konjac]

The fine grain konjac of the invention can be used with an alkali component contained therein, but preferably used after neutralizing the alkali component. Konjac is produced by solidifying konjac root or refined powder of konjac as a raw material using an alkali, such as calcium hydroxide and salt water. The thus produced konjac typically has a pH of 10 to 12. The solidified konjac is usually a shaped konjac, in general, shaped in a form of rectangular, thread, round, grain or plate, and is uncolored or colored. The uncolored one is roughly divided into white konjac that uses no seaweed powder and black konjac that is colored by seaweed powder. The colored konjac is obtained by kneading an oily natural pigment which is hardly eluted into seasoning liquid, into the konjac. Examples thereof include konjacs variously colored by kneading a pigment of yellow (carotene), red (paprika, tomato), brown (cacao), black (squid ink), blue (Gardenia) and/or green (Marigold, Gardenia), as a natural pigment that is not eluted into water and seasoning liquid out of konjac, into the konjac.

The konjac is preferably neutralized into a pH of 2.5 to 7.4. The amount of the acid necessary to neutralize the alkali in the konjac is determined as follows. A given weight of the konjac is ground using a homogenizer, the konjac is mixed with an acidic material in an amount at least capable of neutralizing alkali content of the fine grain konjac. At that time, an organic acid is added and the amount of the acid required to make the pH into a range of 2.6 to 7.4 is measured. Thus, the amount of the acid can be determined. As the organic acid, food additives, such as acetic acid, citric acid, lactic acid, malic acid, gluconic acid, etc., may be chiefly used, and acidic components contained in the seasonings, a fruit juice, and other ingredients are preferably taken into consideration. An acid may be added such that the pH of the product is made into 2.5 to 7.0, preferably into 5.0 to 4.0, in order to enabling distribution at the normal temperature, and then the product is subjected to a heat sterilization, for example, at 85° C. for 30 to 60 minutes. When distribution in a refrigerated, tilled, or frozen form is allowed, a pH up to 7.4 is available, but the pH is preferably adjusted in the range of 2.5 to 7.0, considering the problem of the management after the products are distributed to the consumers.

The neutralization step of the fine grain konjac with an acidic material may be performed in a container, followed by putting the neutralized product in individual packaging containers, but the neutralization may be performed after the fine grain konjac, an organic acid, seasonings, a fruit juice, etc. are enclosed in the individual packaging containers. Alternatively, the neutralization may be performed during the heat sterilization step after all the food materials including the fine grain konjac are enclosed in individual packaging containers for distribution. The material of the packaging container charged with the product is made of a plastic which has heat resistance and smell retaining properties rather than of glass, and a rigid container and a flexible laminate bag, in particular, a retort pouch provide good efficiency in the work. The heat treatment after packaging is intended to quickly neutralize and eliminate the alkali in the konjac and facilitate penetration of seasoning components into the konjac, at the same time sterilization of destructive fungi is also achieved at the same time.

### [Heating Condition]

The produced fine grain konjac is used after the heat sterilization, and the konjac may however be softened or made into gum in some cases depending on the condition of the heat treatment. This phenomenon relates to the pH of the seasoned konjac. The optimal heat condition in light of the texture and storage property is 50 to 95° C. at a pH in the range of 3.5 to 6.0, and 100 to 120° C. at a pH in the range of 6.0 to 9.0, and the treatment time is usually within 60 minutes. In this heat treatment, the seasoning components, but depending on the shape of konjac, may fully permeate and season the konjac until the end of the treatment, and the neutralization of the fine grain konjac into a predetermined pH value may be completed until the end of the heating step.

### [Other Materials Used for Production of Smoothie-Like Food or Drink]

When the smoothie-like food or drink of the invention is produced, an acidic material or a thicker may be appropriately used.

The acidic material includes at least one selected from a seasoning, a thickening substance, a fruit juice, a puree obtained by crushing and straining a fruit and/or a vegetable, a fruit paste, and a vegetable paste, and the pH value is preferably adjusted so that the alkali content of the fine grain konjac can be at least neutralized. The acidic material can allow food materials to be finished such that the vegetable's natural good taste (Umami), color, texture, and flavor are remained in the flesh mixture which has a texture and has a characteristic of favorable texture different from grating texture. In addition, a unique texture of a puree obtained by crushing and straining a fruit and/or a vegetable, a fruit paste, and a vegetable paste can be created.

The thickening substance is not particularly limited, as long as it is a viscous material for food, and may be a natural polysaccharide such as starch and a seaweed component, as well as a natural gum material that is a known food additive, a polysaccharide thickener, and the like. Pectin is widely used in low pH foods. The pectin is roughly divided into high methoxyl pectin and low methoxyl pectin, either one of which is appropriately used according to the desired viscosity or gelating property. As a thickening substance of jam using the fine grain konjac, the low methoxyl pectin is preferably used rather than the high methoxyl pectin. Alternatively, xanthan gum, tamarind gum, guar gum, tara gum, tara bean gum, locust bean gum, carrageenan, etc. may be specifically used.

Since the textures of pulp and skin of a fruit can also be expressed by changing the length, shape, size of the fine grain konjac, part or whole of a natural raw material may also be replaced by the konjac fine grain. The texture varies depending on the kind of the additive used as well. For example, when the amount of the fine grain konjac and a concentrated fruit juice, the kind and quality of the concentrated fruit juice, as well as the kind and amount of the thickener are studied, optimal quality in the viscosity can be determined. The quality in the viscosity is determined by a complex combination of physical properties mainly including viscoelasticity, and therefore the digitization thereof is difficult. It is difficult to determine the optimal value even if measurement data by a special apparatus, such as viscometer, rheometer, and texturometer, are used. Upon determining the optimal quality in the viscosity, there has been no choice but employing the most favorable result of a sensory evaluation using the five senses of human, after all. As the concentrated fruit juice, for example, strawberry, blueberry, or melon may be used.

As the seasoning liquid, acetic acid, sucrose, sorbitol, sodium chloride, sodium glutamate, calcium lactate, beef extract, dark soy sauce, etc. are used here, but any seasoning liquid which is western, Japanese, or Chinese one used for boiled, fried, or marinated food may be used. A concentrated fruit juice, flavor, fruit pulp, and powder of fruit juice, etc. of a fruit such as blueberry and strawberry are used in order to put a fruit flavor.

Furthermore, when using a fine grain konjac colored into various colors, colorful health foods with a playful mind can be expected. The food in which the fine grain konjac is used as a material makes it possible to develop new products having a low calorie content and a healthy sense, and to expand the range of the product using a smoothie-like food or drink.

### [Rare Sugar]

In the processed konjac food or drink of the invention, D-allose or D-psicose, or a mixture thereof is preferably used. The amount of the rare sugar contained in the processed konjac food or drink is in the range allowing an ingestion of 0.3 to 50 g which is an intake in a day for an adult. For example, the content of the rare sugar in a smoothie-like food or drink is 0.1 to 10.0% by weight, preferably 1.0 to 5.0% by weight, and more preferably 1.0 to 2.0% by weight. When the content is less than 0.1% by weight, it may be difficult to ingest 0.3 to 50 g which is a daily intake of an adult and the blood glucose increase suppressing effect may not be sufficiently achieved. On the other hand, a content more than 10% by weight may often result in excessive intake, which is not preferable. Aqueous solutions of these rare sugars are colorless, transparent, and have no smell and a sweet taste. Accordingly, the rare sugars may not impair the appearance or taste when added to the smoothie-like food or drink. With regard to the constituents of the rare sugar, usable is a sweetener (Patent Document 10) which contains fructose in a proportion of 20 to 80 parts by weight, and glucose and psicose in a proportion of 80 to 20 parts by weight in total, wherein psicose is contained in a ratio of 5 parts by weight or more, preferably 10 parts by weight or more, relative to 100 parts by weight of the sum of glucose and psicose, and which has a sweetness and a quality of taste close to a sucrose and prevents lifestyle-related diseases such as obesity. A rare sugar-containing syrup (Rare Sugar Sweet (trade name): the sugar composition is 38% or more of glucose, 25% or more of fructose, about 15% of rare sugars (wherein D-psicose accounts for 5% or more) is commercially available as the sweetener. The rare sugar is a mixture with an isomerized sugar, and it is a rare sugar-containing isomerized sugar having a content of sugars other than D-glucose and D-fructose less than 60% by weight, and obtained by isomerizing one of or two or more of D-glucose, D-fructose and an isomerized sugar by an alkali of 0.005 mol/l or more,

Rare sugar is defined as monosaccharides and sugar alcohols that exist in the natural world only in a minute amount. with regard to hexose, there are 16 kinds of aldose, specifically L-allose, L-gulose, L-glucose, L-galactose, D-altrose, L-idose, L-mannose, L-talose, D-talose, D-mannose, D-idose, D-altrose, D-galactose, D-glucose, D-gulose and D-allose, and 8 kinds of ketose, specifically L-psicose, L-sorbose, L-fructose, L-tagatose, D-tagatose, D-fructose, D-sorbose, and D-psicose. Monosaccharides abundantly existing in the natural world are 7 kinds, that is, D-glucose, D-fructose, D-galactose, D-mannose, D-ribose, D-xylose, and L-arabinose, and all the other monosaccharides are said to be rare sugars.

D-Psicose or D-allose are monosaccharides existing, but in a minute amount, in nature. There is no report that these rare sugars are toxic to human, and it is believed that its toxicity to animals is low.

### [D-Psicose]

D-Psicose is a rare sugar which can be currently mass-produced. D-Psicose is a D-isomer of psicose which belongs to rare sugars and is classified into ketohexose, and is a hexose (C6H12O6). The sweet taste of D-psicose is noble and fresh, has no unpleasantness accompanied with bitterness or astringency like saccharin, and is more similar to the sweet taste of fructose. The sweetness is about 70% of that of sucrose.

D-Psicose is currently produced in general by a method by treating fructose with an enzyme (epimerase), or may be extracted from a natural material. When producing D-psicose, a purified enzyme or a microorganism capable of producing the enzyme may be used. Ketohexose 3-epimerase is an enzyme used in isomerization of OH at 3-position of a ketohexose such as fructose, and the methods using D-tagatose 3-epimerase or D-psicose 3-epimerase are known as well.

Alternatively, a purified enzyme, or an immobilized enzyme in which the enzyme-producing microorganism is immobilized or an immobilized microorganism may be used.

Derivatives of D-psicose are described below.

A compound as a result of converting a molecular structure of a starting compound thorough a chemical reaction is referred to as a derivative of the starting compound. Derivatives of hexoses including D-psicose generally may include, but are not limited to, a sugar alcohol (when reducing a monosaccharide, the aldehyde group and the ketone group become an alcohol group, and the monosaccharide is converted into a polyalcohol having the same valency as the carbon number), an uronic acid (which is produced by oxidizing an alcohol group in a monosaccharide, and D-glucuronic acid, galacturonic acid, and mannuronic acid are known as a natural one), and an amino sugar (which is produced by replacing an OH group in a sugar molecule with an NH2 group, and, for example, glucosamine, chondrosamine, glycoside are included).

### [D-Allose]

Production of D-allose can be achieved by isomerizing D-psicose using L-rhamnose isomerase and isolating D-allose from the mixture. D-Allose which is a rare sugar can be mass-produced from D-psicose using the L-rhamnose isomerase. In order to produce a mixture of D-allose and D-psicose, a method in which D-psicose is subjected to isomerization reaction by the action of L-rhamnose isomerase to prepare the mixture of D-psicose and D-allose is advantageously conducted. The D-psicose and D-allose can be obtained as a mixture without separation.

That is, the processed konjac food or drink of the invention is characterized in that, D-psicose is D-psicose and/or a derivative thereof, and the derivative of D-psicose is selected from a sugar alcohol obtained by converting a ketone group in D-psicose into an alcohol group, a uronic acid obtained by oxidizing an alcohol group in D-psicose, and an amino sugar obtained by replacing an alcohol group in D-psicose with an NH2 group. In addition, the processed konjac food or drink of the invention is characterized in that, D-allose is D-allose and/or a derivative thereof, and the derivative of the D-allose is selected from a sugar alcohol obtained by converting an aldehyde group in D-allose into an alcohol group, a uronic acid obtained by oxidizing an alcohol group in D-allose, and an amino sugar obtained by replacing an alcohol groups in D-allose with an NH2 group.

The smoothie-like food or drink of the invention is described in detail below with reference to Examples, but the invention is not to be limited to the Examples. D-Allose is D-allose and/or a derivative thereof, and the derivative of the D-allose is selected from a sugar alcohol obtained by converting an aldehyde group in D-allose into an alcohol group, an uronic acid obtained by oxidizing an alcohol group in D-allose, and an amino sugar obtained by replacing an alcohol group in D-allose with an NH2 group.

The processed konjac food or drink of the invention is produced by a method for producing konjac having a pH in the range of 2.5 to 7.4 that has been known at the time of filing of this application, except for the technique for allowing a konjac material to contain a rare sugar.

(1) A konjac obtained by solidification with calcium hydroxide is soaked in an organic acid in an amount required to neutralize the alkali in the konjac and a seasoning liquid for imparting flavor to the konjac, to neutralize the konjac and allow the seasoning liquid to permeate the konjac. The seasoning liquid is conditioned beforehand so as to make the pH of the konjac into 2.5 to 7.4. The required amount of the rare sugar may be mixed with the konjac raw materials, or may be mixed with the seasoning liquid to permeate the konjac (see Patent Document 11).

(2) The konjac containing the rare sugar having a pH in the range of 2.5 to 7.4 can be colored as follows. That is, for example, the konjac may be colored to black by kneading konjac raw materials together with powder of a roasted wheat skin and black and red-orange natural pigments (see Patent Document 12), or a pigment is produced by extracting an oil-soluble pigment from an animal or plant and adding thereto an emulsifier to disperse the pigment in water in a form of fine particles, and the konjac may be colored by kneading the konjac together with the obtained natural pigment (see Patent Document 13).

(3) The processed konjac food or drink of the invention may be produced by: adding a raw material powder including konjac, starch, gluten, and wheat into water and stirring the mixture to make a konjac paste; kneading the paste together with calcium hydroxide; passing the mixture through a perforated plate as it is, followed by heating in a hot water bath, to solidify and shape the konjac into noodles of konjac having a pH of 10 to 12; and combining the konjac noodles with an acidic seasoning to adjust the pH into 9 to 3. The konjac food or drink may be a retort pouch food product of the konjac noodles, characterized by retort-treating the noodles in a retort pouch. A raw material powder and/or konjac paste in which a rare sugar is mixed may be used to produce the konjac noodle. The rare sugar may be added to the acidic seasoning to adjust or enhance the amount of the rare sugar (Patent Document 14).

(4) In a method of allowing taste to permeate an Oden konjac (Oden; Japanese soy-source based stew-like food), without heating for a long time, that is, with shorter heating time than a normal konjac without seasonings kneaded therein, characterized in that: konjac powder is mixed and stirred with a hot water solution of seasonings including a seasoning having a good taste (Umami) composed of at least two seasonings selected from the group consisting of sodium glutamate, sodium inosinate, sodium guanilate, sodium succinate, a meat extract, a fish extract, a shellfish extract, and a vegetable extract (at least containing sodium inosinate and sodium succinate), a seasoning providing a salty taste, and a seasoning providing a sweet taste, thereby producing a konjac paste; calcium hydroxide is added thereto to form gel, obtaining seasoned konjac having a pH of 11 or higher which is distributable at normal temperature; and the resulting konjac without dealkalization is further boiled in an Oden-cooking liquid for 5 to 10 minutes in a state where alkali remains, to allow the oden taste to penetrate the konjac, obtaining an eatable Oden konjac, a required amount of rare sugar may be mixed with the konjac raw materials, or may be mixed in the seasoning liquid to permeate the konjac (see Patent Document 15).

The processed konjac food or drink in the invention is intended to allow a rare sugar to be ingested in a daily dose of 0.3 to 50 g/day together with konjac, in order to suppress blood glucose increase. The product is intended to allow the daily dose of the rare sugar to be invested together with konjac, in a form containing 40 to 95% by weight of konjac, and 0.1 to 10.0% by weight of the rare sugar, based on the whole food and drink. The product is intended to allow the daily dose of the rare sugar to be ingested together with konjac, in at least once a day. The invention also relates to a food product in container containing a processed konjac food or drink having blood glucose increase suppressing effect, and 0.3 to 50 g of a rare sugar which is an intake required for one day is contained together with konjac in one container.

The present invention is described in detail with reference to Examples. The invention is not to be limited to the Examples in any way.

### Example 1

### Production of Smoothie Using Fine Grain Konjac and Rare Sugar

A seasoning liquid having a composition shown in Table 1 was prepared by mixing a concentrated blueberry juice, sweeteners such as reduced sugar syrup and sucrose, an acidulant such as malic acid, a thickener such as xanthan gum, and water. The seasoning (300 g) of pH 3.0 was mixed with a fine grain konjac (1 kg) having a grain size of 0.1 mm to 1 mm, and D-psicose (70.0 g as the solid form) was added to the mixture, followed by mixing for 5 seconds in a high-speed mixer. The resulting mixture was placed in a polypropylene container and heated at 120° C. for 15 minutes. The obtained smoothie-like processed food had a pH of 3.7 and a sugar content of 11.4%. The detail of the raw materials, such as components, kinds and blending ratio is shown in Table 1.

This product contained about 5% by weight of D-psicose, and thus, about 5 g of D-psicose could be ingested when eating or drinking 100 g of the product. The product was tested by 10 panelists, and as a result, it was confirmed that the product had a texture as smoothie.

TABLE 1
Seasoning Liquid

| | % |
|---|---|
| Concentrated fruit juice (blueberry) | 35.0 |
| Reduced sugar syrup | 16.8 |
| Sucrose | 14.0 |
| Malic acid | 1.2 |
| Xanthan gum | 1.0 |
| Cone starch | 0.7 |
| Blueberry flavor | 0.5 |
| Calcium lactate | 0.5 |
| Sodium ascorbate | 0.4 |
| Sucralose | 0.3 |
| Water | 29.6 |

Ground konjac 1 kg
Seasoning liquid above 300 g
High-speed mixing for 5 seconds
Seasoning liquid pH: 3.0
Product pH: 3.7
Sugar content: 11.4%

### Example 2

A blueberry smoothie-like food or drink was produced by the same procedure as in Example 1. The composition of the seasoning liquid is shown in Table 2. D-psicose (15 g) was added thereto to produce a blueberry smoothie-like food or drink containing about 1% by weight of D-psicose. All of ten panelists who ate the smoothie-like food or drink determined that the product had a good flavor and texture as smoothie.

TABLE 2
Blueberry Smoothie
Seasoning Liquid

| | % |
|---|---|
| Reduced sugar syrup | 15.0 |
| Sucrose | 5.0 |
| Malic acid | 2.3 |
| Sodium malate | 0.5 |
| pH Modifier | 1.7 |
| Sucralose | 0.8 |
| Calcium lactate | 0.5 |
| Sodium ascorbate | 0.5 |
| Xanthan gum | 1.0 |
| Cone starch | 0.6 |
| Yogurt flavor | 0.3 |
| Blueberry flavor | 1.6 |
| Fruit juice powder (blueberry) | 5.5 |
| Tomato pigment | 0.1 |
| Gardenia blue pigment | 0.4 |
| Water | 64.2 |

Ground konjac 1 kg
Seasoning liquid above 300 g
High-speed mixing for 10 seconds × 3 times
Seasoning liquid pH: 3.2
Product pH: 3.9
Sugar content: 6.4%

### Example 3

A strawberry smoothie was produced with the same procedure as in Example 1, except that a seasoning liquid having the composition shown in Table 3 was used and 70 g of a rare sugar composed of a mixture of D-psicose and D-allose was added in place of D-psicose. All of ten panelists determined that the product was favorable as smoothie.

TABLE 3
Strawberry Smoothie
Seasoning Liquid

| | % |
|---|---|
| Reduced sugar syrup | 15.0 |
| Sucrose | 5.0 |
| Malic acid | 2.3 |
| Sodium malate | 0.5 |
| pH Modifier | 1.7 |
| Sucralose | 0.8 |
| Calcium lactate | 0.5 |
| Sodium ascorbate | 0.5 |
| Xanthan gum | 1.0 |
| Cone starch | 0.6 |
| Yogurt flavor | 0.3 |
| Strawberry flavor | 1.6 |
| Fruit juice powder (strawberry) | 5.5 |
| Tomato pigment | 0.2 |
| Water | 64.5 |

Ground konjac 1 kg
Seasoning liquid above 300 g
High-speed mixing for 10 seconds × 3 times
Seasoning liquid pH: 3.3
Product pH: 3.9
Sugar content: 6.2%

### Example 4

A test was performed for demonstrating the blood glucose increase suppressing effect of a smoothie-like food or drink as the processed konjac food or drink having blood glucose increase suppressing effect.

This test was performed with the cooperation of seven health volunteers (2 males and 5 females) not falling under the following exclusion criteria.

<Exclusion Criteria>

(1) Person having a medication allergy against the D-psicose component

(2) Person suffering from type 1 diabetes

(3) Person having an experience of diabetic ketoacidosis (which is a state of excessively high blood glucose level, where blood is acidic, and deteriorated diabetes symptoms, such as feeling of dry mouth, polydipsia, lassitude, and weight reduction may occur, and if further progressing, blood pressure reduction, tachycardia, or disturbed consciousness may be caused)

(4) Person suffering from severe renal disorder, hepatic disorder, cardiac disorder, or other severe complication, who is determined by the attending physician not to be appropriate as the subject

(5) Person currently suffering from an infectious disease, or person who has had or is scheduled surgery

(6) Pregnant or lactating woman

(7) Person currently participating in another clinical trial

(8) Other person who is determined by a physician in charge or partly in charge of the test not to be appropriate as the subject of the test

### [Test Method]

The test was performed according to the following procedure.

(1) Fasted from 9 pm and gathered at the next 8:30 am.

(2) Drink one of the following items 30 minutes before the start of a 75 g-glucose tolerance test.
A: Nothing (no-addition)
B: D-Psicose (5 g) dissolved in water (50 ml)
C: Mannan smoothie (containing 82.5% of konjac)
D-psicose (5 g)
D: Mannan smoothie (containing 82.5% of konjac)
E: Mannan smoothie (containing 41.25% of konjac)

(3) Receive blood collection after 30 minutes (0-minute value).

(4) Ingest a drink containing 75 g of D-glucose immediately after the blood collection.

(5) Receive blood collections after 30, 60, and 120 minutes after the ingestion (30-minute value, 60-minute value, and 120-minute value, respectively).

(6) Measure the blood glucose levels after serum separation.

### [Analysis of Test Result]

Since all the subjects showed a normal glucose tolerance, all the data were used for the analysis.

As shown in FIG. 1, the results of the blood collections from the 5 groups, A to E, were compared, and then the following findings were obtained.
Group A (no-addition group, under only the ordinary OGTT) was higher in all the 30-minute, 60-minute, and 120-minute values than the other groups.
Group B (preadministration of 5 g of D-psicose) gave a certain level (5 to 10 mg/dl) of blood glucose suppressing effect in comparison with Group A.
In Group C (preadministration of mannan smoothie [containing 82.5% of konjac]+5 g of D-psicose), the blood glucose increase was the lowest throughout the whole test.
Group D (preadministration of mannan smoothie [containing 82.5% of konjac] alone) was lower in 30-minute value and 120-minute value than Group A.
Group E (preadministration of mannan smoothie [containing 41.25% of konjac] alone) showed a blood glucose reduction effect second to Group C.

It was considered from the test results that both D-psicose and mannan smoothie had a certain level of blood glucose increase suppressing effect.

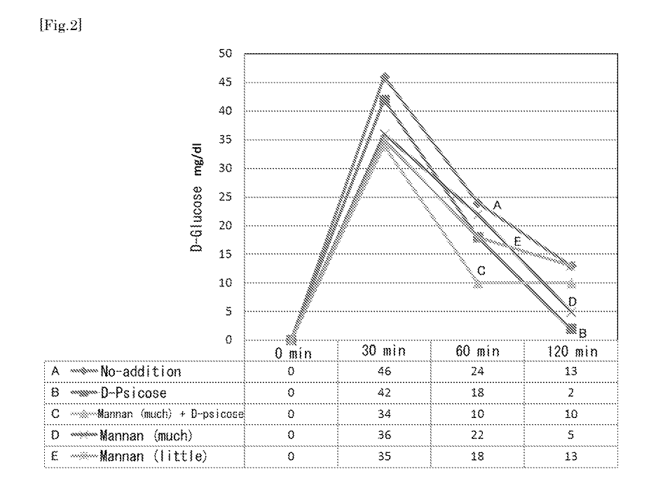

In the 75 g-glucose tolerance test, Group A, Group B, and Group D were tested in the morning and Group C and Group B were tested in the afternoon. In addition, mannan smoothies have a certain level of calorie content, and therefore, for the purpose of comparing all the groups under the same condition, the 0-minute value was subtracted from the 30-minute, 60-minute, and 120-minute values in each measurement to obtain variations from the 0 minute at the time points of 30, 60, and 120 minutes, and the variations were compared to each other. The results are shown in FIG. 2. The result gives the following findings.
Group A (no-addition group, under only the ordinary OGTT) was higher in all the 30-minute, 60-minute, and 120-minute values than the other groups.
Group B (preadministration of 5 g of D-psicose) showed a certain level (5 to 10 mg/dl) of blood glucose suppressing effect in comparison with Group A.
Group C (preadministration of mannan smoothie [containing 82.5% of konjac]+5 g of D-psicose) showed the largest blood glucose increase suppressing effect in the 30-minute value and 60-minute value, and gave values 12 mg/dl and 14 mg/dl, respectively, lower than Group A. The increase of the blood glucose level was the lowest throughout the whole test.
Group D (preadministration of mannan smoothie [containing 82.5% of konjac] alone) gave lower values in all the 30-minute, 60-minute, and 120-minute values than those of Group A.
Group E (preadministration of mannan smoothie [containing 41.25% of konjac] alone) showed about 5 to 10 mg/dl of suppressions in 30-minute value and 60-minute value, in comparison with Group A.

### [Result of Consideration]

The above administration test revealed the followings.

(1) A blood glucose increase suppressing effect as a result of ingestion of 5 g of D-psicose was recognized.

(2) Some effect was recognized with a mannan smoothie [containing 82.5% of konjac] alone and a mannan smoothie [containing 41.25% of konjac] alone.

(3) A combination use of a mannan smoothie [containing 82.5% of konjac]+5 g of D-psicose had the highest blood glucose increase suppressing effect, and it was shown that the additive effect of the both was potentially expected.

FIG. 2 shows a graph in which the mean values of the measured data were calculated and the initial point of the data was taken into consideration (the blood glucose value at the elapsed time of 0 minute was taken to be 0). From the test result shown in FIG. 2, it was found that the blood glucose increase in the glucose tolerance test was suppressed by drinking a mannan smoothie, but an excellent blood glucose increase suppressing effect which can not be achieved by ingesting konjac alone was obtained by drinking a rare sugar at the same time.

That is, it was demonstrated that the smoothie-like food or drink of the invention containing fine grain konjac and a rare sugar had a blood glucose increase suppressing effect. In addition, it has been found from another test result that the blood glucose increase suppressing effect lasted for about one day after drinking.

### Example 5

Effects of a mannan smoothie and a rare sugar-containing syrup (Rare Sugar Sweet: RSS) on a glucose tolerance test was analyzed.

It was shown in a human test in Example 4 that a synergistic effect on suppression of blood glucose increase could be obtained by combining D-psicose and a mannan smoothie.

It was studied in Example 5 whether or not the same effect as in the case of D-psicose alone could be obtained with the use of an RSS-containing mannan smoothie which has been already made into a product, by using a rare sugar-containing syrup (Rare Sugar Sweet: RSS) in place of the D-psicose.

[Subjects]

This test was performed with the cooperation of five healthy volunteers (2 males and 3 females) not falling under the following exclusion criteria.

<Exclusion Criteria>

(1) Person having a medication allergy against the D-psicose component

(2) Person suffering from type 1 diabetes

(3) Person having an experience of diabetic ketoacidosis (which is a state of excessively high blood glucose level, where blood is acidic, and deteriorated diabetes symptoms, such as feeling of dry mouse, polydipsia, lassitude, and weight reduction may occur, and if further progressing, blood pressure reduction, tachycardia, or disturbed consciousness may be caused)

(4) Person suffering from severe renal disorder, hepatic disorder, cardiac disorder, or other severe complication, who is determined by the attending physician not to be appropriate as the subject

(5) Person currently suffering from an infectious disease, or person who has had or is scheduled surgery

(6) Pregnant or lactating woman

(7) Person currently participating in another clinical trial

(8) Other person who is determined by a physician in charge or partly in charge of the test not to be appropriate as the subject of the test

### [Place of Test]

Department of Clinical Trial, University Hospital, Faculty of Medicine, Kagawa University

### [Method]

(1) Fasted from 9:00 pm and gathered at the next 9:00 am.

(2) A 75 g oral glucose tolerance test (OGTT) was performed as follows.
I: Drink only Toleran G containing 75 g of glucose.
II: Drink 100 g of an RSS-containing mannan smoothie (containing 0.3 g or more of D-psicose, 2.0 g or more of D-glucose, 1.3 g or more of D-fructose, and 82.5 g of konjac) 30 minutes before taking the Toleran G containing 75 g of glucose.

(3) Receive blood collection 30 minutes, 60 minutes, and 120 minutes after the glucose drinking (30-minute value, 60-minute value, and 120-minute value, respectively).

(4) Measure the blood glucose levels after serum separation.

### [Composition of Mannan Smoothie]

Konjac 82.5%
Rare Sugar Sweet 5.5% or more (including 0.3% or more of D-psicose)
Fruit juice powder 1.2%
Other food additives (pH modifier, thickener (xanthan gum, modified starch), flavor, sweetener (sucralose), calcium lactate, antioxidant (V.C), natural pigment) 2.4%
Water 8.4%

### [Results]

In the glucose tolerance test, Nos. 1 to 4 showed normal type and No. 5 showed impaired glucose tolerance (IGT), but there was no diabetic type.

I: Case of drinking only a 75 g-glucose drink (performed in the morning)

The results are shown in Table 4.

TABLE 4

| | | | | | | | Zero |
|---|---|---|---|---|---|---|---|
| GLU | | | | | | Mean | correction |
| (mg/dl) | 1 | 2 | 3 | 4 | 5 | value | value |
| 0 min | 91 | 104 | 99 | 99 | 100 | 99 | 0 |
| 30 min | 127 | 148 | 157 | 171 | 138 | 148 | 49 |
| 60 min | 113 | 160 | 165 | 149 | 164 | 150 | 51 |
| 120 min | 110 | 119 | 97 | 129 | 152 | 121 | 22 |

(Zero correction value: a value obtained by subtracting the 0-minute value from each value)

II: Case of drinking an RSS-containing mannan smoothie 30 minutes before taking the Toleran G containing 75 g of glucose.

The results are shown in Table 5.

TABLE 5

| | | | | | | | Zero |
|---|---|---|---|---|---|---|---|
| GLU | | | | | | Mean | correction |
| (mg/dl) | 1 | 2 | 3 | 4 | 5 | value | value |
| 0 min | 118 | 90 | 71 | 115 | 124 | 104 | 0 |
| 30 min | 103 | 99 | 115 | 131 | 125 | 115 | 11 |
| 60 min | 95 | 98 | 116 | 126 | 127 | 112 | 8 |
| 120 min | 123 | 65 | 120 | 76 | 116 | 100 | −4 |

(Zero correction value: a value obtained by subtracting the 0-minute value from each value)

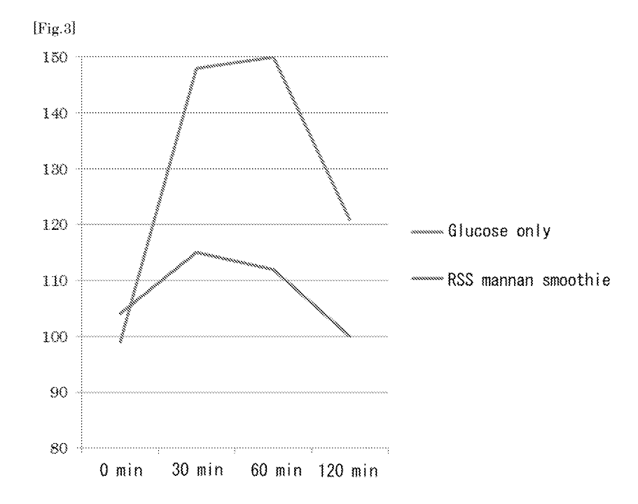

The found values of the variation of blood glucose level were shown in FIG. 3, and the results after the zero correction of the variation of blood glucose level were shown in FIG. 4.

As a result of comparing the results of blood collections in Group I and Group II, the following findings were given.
Group I (only a normal 75 g glucose tolerance test) showed clearly higher values in all the 30-minute, 60-minute, and 120-minute values than Group II who ingested an RSS-containing mannan smoothie together with 75 g of glucose.
Significant differences were recognized especially in the 30-minute and 60-minute values. In the 120-minute value, the blood glucose level was not get back to the level before eating yet in Group I, whereas it returned to the level before eating in Group II.
In the case where an impaired glucose tolerance was shown in the OGTT, the 2-hour value was get back to a normal value after ingestion of the RSS-containing mannan smoothie, and the high blood glucose level after the glucose load was suppressed.

### [Consideration]

This study revealed the followings.

1. When an RSS-containing mannan smoothie was ingested before taking 75 g of glucose, a blood glucose increase suppressing effect after glucose load clearly greater than the case of ingestion of 75 g glucose alone was recognized in all the 30-minute, 60-minute, and 120-minute values.

2. The ingestion of 100 g of the RSS-containing mannan smoothie corresponds to additional ingestion of 2.0 g or more of glucose, 1.3 g or more of fructose, and 13.9 g of the other ingredients, nevertheless the increase of blood glucose level was still suppressed. This is considered due to the synergistic effect of the konjac component (content: 82.5 g*) and the components, mainly the rare sugars such as D-psicose (content: 0.3 g or more), contained in 5.5 g of RSS, contained in the RSS-containing mannan smoothie.

3. When a patient having impaired glucose tolerance ingested 100 g of the RSS-containing mannan smoothie, the postprandial blood glucose level was suppressed. A high postprandial blood glucose level is the most critical risk factor for onset of arteriosclerosis diseases in diabetes. Accordingly, if the high postprandial blood glucose can be suppressed by the ingestion of 100 g of the RSS-containing mannan smoothie, this product will attract attention as a new approach of diabetic treatment.

4. Those results show excellent effects beyond expectation, and are believed to be novel findings which have never been reported.

5. A human long-term test (3 months) using RSS-containing mannan smoothie will be continued in the future to verify the above findings in more detail, and it has been already started with the approval of the ethics committee of Kagawa University. * About 10% glucomannan is contained in konjac root, and in glucomannan, glucose and mannose are connected by a β-1,4-linkage in a ratio of 5:8. A purified konjac obtained by further processing the root is used in this product. It is difficult to determine the correct contents of mannose and glucose in the konjac component.

### Example 6

The other foods or drinks including a rare sugar-containing konjac are exemplified in the following Examples, and these foods or drinks have the same physiological effect as the smoothies described above.

### [Production of Salad Konjac 1]

Acidulants, such as malic acid, calcium lactate and sodium ascorbate, water, and a rare sugar-containing syrup were mixed to produce a seasoning liquid of pH 3.0 shown in Table 6, and 300 g of the seasoning liquid was mixed with 1 kg of a konjac shaped in a form of plate of 40×15×2 mm, followed by mixing for 5 seconds in a high speed mixer. The resulting konjac was put in a polypropylene container together with the seasoning liquid and heated at 120° C. for 15 minutes. The thus produced processed plate food had a pH of 3.7. This product had the seasoning liquid containing the rare sugar penetrating therein.

The processed plate konjac food was added, as it was or after cutting into any shape, to cut vegetables to prepare a vegetable salad.

TABLE 6
3-color salad konjac
Recipe of seasoning liquid

| | |
|---|---|
| Malic acid | 1.7% |
| Sodium L-ascorbate | 0.3% |
| Calcium lactate | 0.4% |
| Italian lemon essence | 0.5% |
| Sodium malate | 0.6% |
| Rare sugar-containing syrup | 22.0% |
| (Rare Sugar Sweet) | |
| Water | 74.5% |

3-color salad konjac 1 kg
Seasoning liquid above 300 g
Seasoning liquid pH: 3.30
Sugar content: 10.2%
Salt content: 0.2%
Finished pH 3.70
Sugar content 4.0%
Salt content 0.1%

### [Production of Salad Konjac 2]

Hot water (40 to 50° C., 100 L) was added to D-allose (10 kg) and konjac powder (3 kg), and the mixture was stirred and mixed slowly to form a paste. After allowing the paste to stand for 2 hours, 1.7% calcium hydroxide solution (10 L) was added to the konjac paste, and the mixture was uniformly kneaded into gel while placing the gel into a molding box, followed by heating with boiled water to solidify the konjac, thereby producing a solidified konjac containing about 9% by weight of D-allose. After that, the solidified konjac was cut into rectangular plates with a size of 2 mm thickness, 15 mm width and 40 mm length to obtain a large number of plate konjac. The plate konjac was put in a container together with a seasoning liquid and subjected to an operation at 120° C. for 20 minutes. In addition, various pigments, such as red, yellow, and green, were added when producing the solidified konjac, thereby producing rare sugar-containing colored konjac plates having different hues. The thus produced konjac plates with different hues were appropriately mixed and put in a polypropylene container together with a seasoning liquid, followed by a heat treatment.

The components of the seasoning liquid included 0.1% of sodium inosinate, 1.0% of sodium glutamate, 0.4% of sodium succinate, 20.0% of reduced sugar syrup, 2.3% of sodium chloride, and 1.0% of malic acid, and its pH value was 3.7.

### [Production of Salad Konjac 3]

Hot water (40 to 50° C., 100 L) was added to D-psicose (5 kg) and konjac powder (3 kg), and the mixture was stirred and mixed slowly to form a paste. After allowing the paste to stand for 2 hours, 1.7% calcium hydroxide solution (10 L) was added to the konjac paste, and the mixture was uniformly kneaded into gel while placing the gel into a molding box, followed by heating with boiled water to solidify the konjac, thereby producing a solid konjac containing about 4.5% by weight of D-psicose. After that, the solidified konjac was cut into rectangular plates with a size of 2 mm thickness, 15 mm width and 40 mm length to obtain a large number of plate konjac. The plate konjac (5 kg) and an acidic seasoning liquid (10 kg) were mixed in a sealed vacuum can including a vacuum inclined shaft kneader and subjected to an operation under a vacuum of 0.07 to 0.08 Mpa at a temperature of 70° C. for 1 hour with stirring. The components of the acidic seasoning liquid included 0.1% of sodium inosinate, 1.0% of sodium glutamate, 0.4% of sodium succinate, 20.0% of reduced sugar syrup, 2.3% of sodium chloride, and 1.0% of malic acid, and its pH value was 3.7.

In addition, various pigments, such as red, yellow, and green, were added when producing the solidified konjac, to produce colored konjac plates having different hues, followed by a heat treatment in a seasoning liquid by the same procedure as in the above.

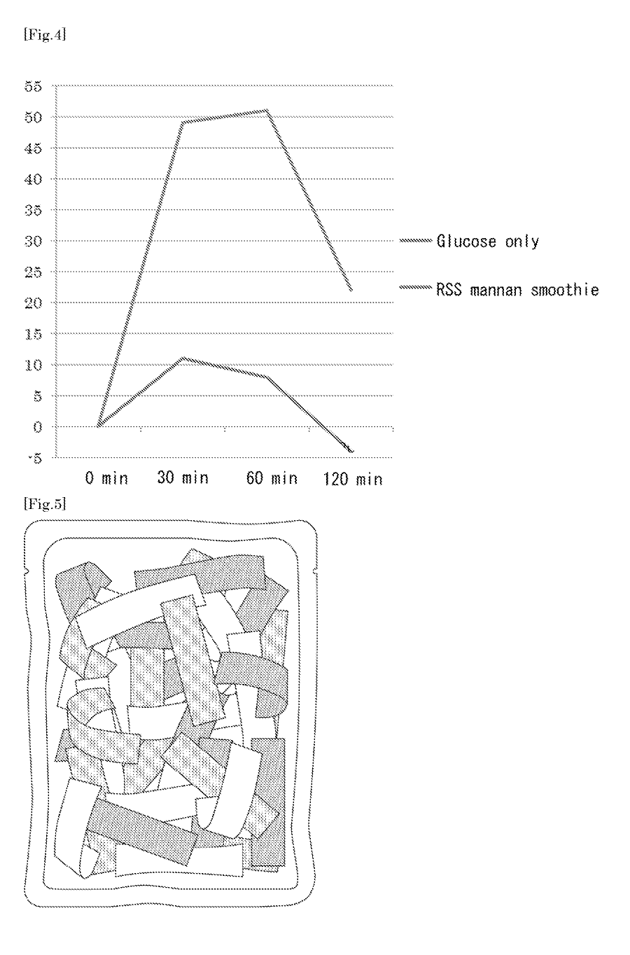

The thus produced konjac plates with different hues were appropriately mixed and put in a polypropylene container together with a seasoning liquid. The appearance of the container containing the salad konjac plates with different hues therein is shown in FIG. 5.

### [Production of Konjac for Seasoned Tuna Rice Bowl]

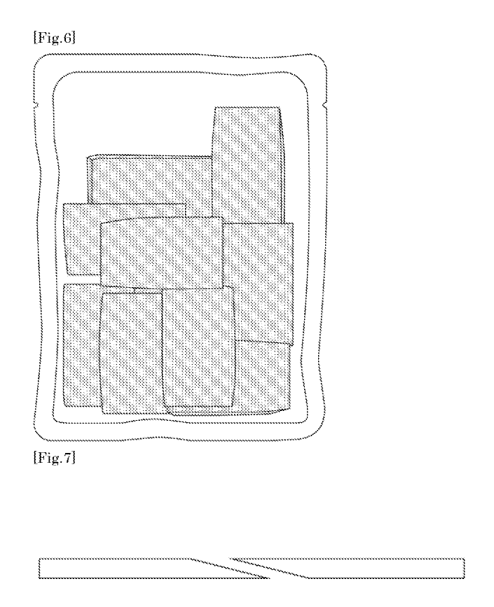

Konjac pieces having similar taste and texture as tuna slice for seasoned tuna rice bowl were produced. The appearance of a container containing konjac for seasoned tuna rice bowl therein is shown in FIG. 6.

Hot water (40 to 50° C., 100 L) was added to D-psicose (5 kg), konjac powder (3 kg) and a colorant, and the mixture was stirred and mixed slowly to form a paste. After allowing the paste to stand for 2 hours, 1.7% calcium hydroxide solution (10 L) was added to the konjac paste, and the mixture was uniformly kneaded into gel while placing the gel into a molding box, followed by heating with boiled water to solidify the konjac, thereby producing a solidified konjac. After that, the solidified konjac was shaped into a rectangular konjac plates with a size of 7 mm thickness, 30 mm width and 45 mm length in which a part was cut off such that the thickness was gradually reduced in the longitudinal direction nearly from the center (20 mm from a short side). The cross section of the konjac plate is shown in FIG. 7. Ten of the konjac plates were enclosed in a polypropylene container of 120×150 mm together with the seasoning liquid shown in Table 7, followed by heating at 120° C. for 15 minutes, thereby producing a konjac for seasoned tuna rice bowl.

The shaped konjac product can present a texture similar to tuna slice by gradually reducing the thickness nearly from the longitudinal center toward the end. For example, the tuna slice-like konjac preferably has a shape of plate with a size of 5-8 mm thickness, 40-50 mm length and 25-35 mm width in which the thickness is gradually reduced nearly from the center in the longitudinal direction. A sensory evaluation showed that the shape provided not a konjac texture but a tuna texture.

TABLE 7
Seasoned tuna-like
Seasoning liquid recipe

| | |
|---|---|
| Soy sauce | 6.3% |
| Mirin (Japanese sweet | 2.0% |
| seasoning liquor) | |
| Sucrose | 0.5% |
| Fish sauce | 0.2% |
| Brewed vinegar | 0.1% |
| Seafood extract | 0.1% |
| Fructose glucose liquid sugar | 0.1% |
| Sea tangle extract | 0.1% |
| Brown molasses | 0.1% |
| Yeast extract | 0.1% |
| Modified starch | 0.1% |
| Sodium chloride | 5.0% |
| 50% gluconic acid | 10.0% |
| Shirodashi (Japanese white | 6.0% |
| soup stock) | |
| Sodium gluconate | 0.6% |
| Sodium succinate | 0.6% |
| Sodium inosinate | 0.4% |
| Sodium L-ascorbate | 0.2% |
| Calcium lactate | 0.4% |
| Rare sugar-containing syrup | 14.5% |
| (Rare Sugar Sweet) | |
| Water | 52.6% |

Tuna-like konjac 1 kg
Seasoning liquid above 250 g
Seasoning liquid pH: 3.43
Sugar content: 37.7%
Salt content: 5.7%
Finished pH 4.11
Sugar content 10.8%
Salt content 1.7%

### [Production of Caviar-Like Konjac]

Hot water (40 to 50° C., 100 L) was added to a mixture of D-psicose (5 kg), konjac powder (3 kg) and a black colorant, and the resulting mixture was stirred and mixed slowly to form a paste. After allowing the paste to stand for 2 hours, 1.7% calcium hydroxide solution (10 L) was added to the konjac paste, and the mixture was uniformly kneaded into gel while extruding the gel from a large number of fine apertures and cutting the extruded konjac at the exits of the apertures into fine grains. The grains were heated and solidified in boiled water, thereby producing solidified black konjac grains.

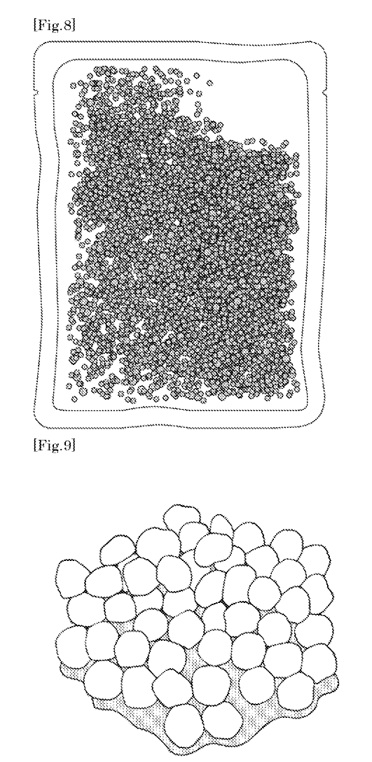

The konjac grains were enclosed in a polypropylene container of 120×150 mm together with the seasoning liquid shown in Table 8, followed by heating at 120° C. for 15 minutes, thereby producing caviar-like konjac grains. The appearance of the enclosed caviar-like konjac grains is shown in FIG. 8.

TABLE 8
Caviar-like
Seasoning liquid recipe

| | |
|---|---|
| 50% gluconic acid | 9.0% |
| Sodium gluconate | 2.0% |
| Sodium chloride | 17.0% |
| Sodium L-ascorbate | 0.4% |
| Calcium lactate | 0.4% |
| Shirodashi | 4.0% |
| Egg flavor | 0.1% |
| Laver flavor | 0.2% |
| Xanthan gum | 0.5% |
| Cone starch | 0.4% |
| Rare sugar-containing syrup | 22.0% |
| (Rare Sugar Sweet) | |
| Water | 44.0% |

Caviar-like konjac 1 kg
Seasoning liquid above 300 g
Seasoning liquid pH: 3.03
Sugar content: 35.2%
Salt content: 11.8%
Finished pH 3.70
Sugar content 7.8%
Salt content 3.0%

### Example 7

### Production of Takowasabi-Like Konjac (Takowasabi: Octopus Spiced with Horseradish

Water was added to konjac powder and the mixture was mixed and stirred to form konjac paste, calcium hydroxide was added to the konjac paste, and the paste was uniformly kneaded into gel while extruding the gel from a large number of fine apertures and cutting the extruded konjac at the exits of the apertures into konjac spheres of about 5 mm to 20 mm. The konjac spheres (1 kg) were soaked in a seasoning liquid (300 g) containing horseradish and a rare sugar shown in Table 9, followed by heating at 120° C. for 15 minutes, thereby producing Takowasabi-like konjac. The octopus-like konjac after the heat treatment had a pH value of 4.08, a sugar content of 7.6%, and a salt content of 1.8%. A drawing created from a photograph of the appearance of the finished product with the seasoning entangled therein is shown in FIG. 9.

TABLE 9
Takowasabi-like konjac
Seasoning liquid recipe

| | |
|---|---|
| Sodium chloride | 10.0% |
| Horseradish | 0.7% |
| Red bell pepper chip | 0.1% |
| 50% gluconic acid | 6.5% |
| Sodium gluconate | 1.5% |
| Xanthan gum | 0.5% |
| Calcium lactate | 0.4% |
| Sodium L-ascorbate | 0.3% |
| Modified starch | 0.3% |
| Sodium inosinate | 0.2% |
| Flavor | 0.1% |
| Gardenia pigment | 0.1% |
| Marigold pigment | 0.1% |
| Carthamus Yellow pigment | 0.1% |
| Shirodashi | 6.0% |
| Sugars (isomerized sugar | 1.6% |
| syrup, sugar syrup) | |
| Cyclodextrin | 0.2% |
| Emulsifier | 0.1% |
| Reduced sugar syrup | 11.0% |
| Rare sugar-containing syrup | 11.0% |
| (Rare Sugar Sweet) | |
| Water | 49.2% |

Tuna-like konjac 1 kg
Seasoning liquid above 300 g
Finished pH 4.08
Sugar content 7.6%
Salt content 1.8%

### [Production of Squid Mentaiko-Like Konjac]

Water was added to konjac powder and the mixture was mixed and stirred to form konjac paste, calcium hydroxide was added to the konjac paste, the paste was uniformly kneaded into gel, and the gel was shaped into rectangular columns of about 5 mm×5 mm×50-70 mm. The konjac columns (1 kg) were mixed with the squid-like konjac seasoning (300 g) shown in Table 10, followed by heating at 120° C. for 20 minutes, thereby producing squid-like konjac.

Next, the konjac gelated with calcium hydroxide was ground into a diameter of 0.1 mm to 3 mm, and then the ground konjac (1 kg) was mixed with the Mentaiko-like konjac seasoning (300 g) containing a rare sugar shown in Table 11, followed by heat treatment at 120° C. for 15 minutes, thereby producing Mentaiko-like konjac.

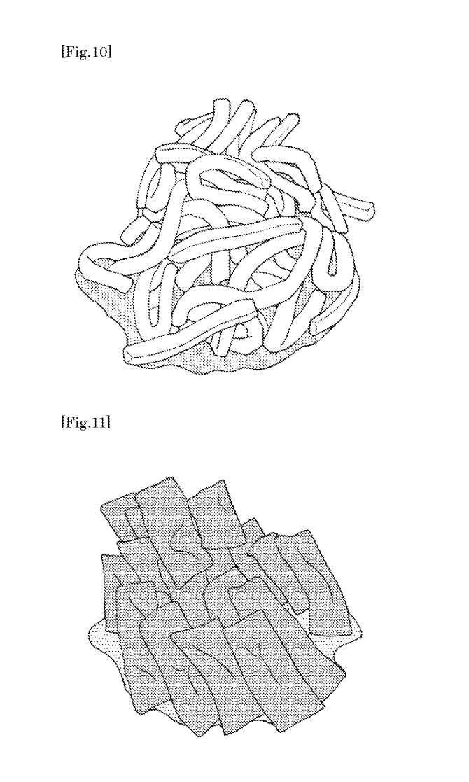

With respect to 1 part by weight of the squid-like konjac produced above, 0.4 parts by weight of the Mentaiko-like konjac was mixed, thereby producing Squid Mentaiko-like konjac. The Squid Mentaiko-like konjac after the heat treatment had a pH value of 4.00, a sugar content of 8.2%, and a salt content of 1.9%. A drawing created from a photograph of the appearance of the finished product with the seasoning entangled therein is shown in FIG. 10.

TABLE 10
Squid Mentaiko-like konjac
Squid konjac seasoning liquid recipe

| | |
|---|---|
| gluconic acid | 6.0% |
| Sodium gluconate | 1.5% |
| Sodium chloride | 10.0% |
| Calcium lactate | 0.4% |
| Shirodashi | 5.0% |
| flavor | 0.6% |
| Sodium inosinate | 0.2% |
| Reduced sugar syrup | 11.0% |
| Rare sugar-containing syrup | 11.0% |
| (Rare Sugar Sweet) | |
| Water | 54.3% |

Squid-like konjac 1 kg
Seasoning liquid above 300 g

TABLE 11
Mentaiko-like konjac seasoning liquid recipe

| | |
|---|---|
| gluconic acid | 4.7% |
| Sodium gluconate | 1.1% |
| Sodium chloride | 8.5% |
| Calcium lactate | 0.3% |
| Shirodashi | 4.5% |
| Flavor | 0.4% |
| Sodium inosinate | 0.2% |
| Sodium L-ascorbate | 0.2% |
| Cone starch | 1.0% |
| Xanthan gum | 1.5% |
| Reduced sugar syrup | 7.5% |
| Rare sugar-containing syrup | 7.5% |
| (Rare Sugar Sweet) | |
| Water | 62.6% |

Mentaiko-like konjac (ground) 1 kg
Seasoning liquid above 300 g
Finished pH 4.00%
Sugar content 8.2%
Salt content 1.9
* Mixing in Squid-like konjac:Mentaiko-like konjac = 1:0.4

### [Production of Smoked Salmon-Like Konjac]

Water was added to konjac powder and the mixture was mixed and stirred to form konjac paste, calcium hydroxide was added to the konjac paste, the paste was uniformly kneaded into gel, and the gel was shaped into plates of about 25 mm×3 mm×50-70 mm. The konjac plates (1 kg) were mixed with the seasoning (300 g) containing a rare sugar shown in Table 12, followed by heating at 120° C. for 15 minutes, thereby producing smoked salmon-like konjac. The smoked salmon-like konjac after the treatment had a pH value of 4.03, a sugar content of 9.8, and a salt content of 2.0%. A drawing created from a photograph of the appearance of the finished product with the seasoning entangled therein is shown in FIG. 11.

TABLE 12
Smoked salmon-like
Seasoning liquid recipe

| | |
|---|---|
| Soy sauce | 8.0% |
| Mirin | 2.5% |
| Sucrose | 0.7% |
| Fish sauce | 0.2% |
| Brewed vinegar | 0.2% |
| Seafood extract | 0.2% |
| Fructose glucose liquid sugar | 0.1% |
| Sea tangle extract | 0.1% |
| Brown molasses | 0.1% |
| Yeast extract | 0.1% |
| Modified starch | 0.1% |
| Sodium chloride | 9.0% |
| 50% gluconic acid | 6.0% |
| Sodium gluconate | 1.5% |
| Flavor | 0.4% |
| Calcium lactate | 0.4% |
| Sodium L-ascorbate | 0.3% |
| Shirodashi | 10.0% |
| Reduced sugar syrup | 11.0% |
| Rare sugar-containing syrup | 11.0% |
| (Rare Sugar Sweet) | |
| Water | 38.1% |

Salmon-like konjac 1 kg
Seasoning liquid above 300 g
Finished pH 4.03
Sugar content 9.8%
Salt content 2.0%

### [Production of Liver Sashimi-Like Konjac]

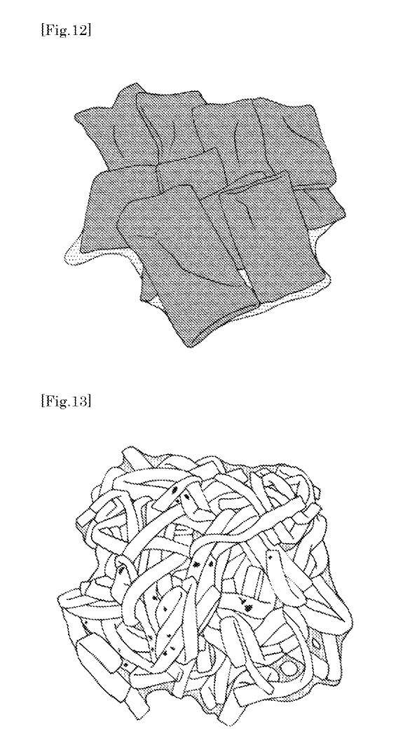

Water was added to konjac powder and the mixture was mixed and stirred to form konjac paste, calcium hydroxide was added to the konjac paste, the paste was uniformly kneaded into gel, and the gel was shaped into plates of about 35 mm×5 mm×30-70 mm. The konjac plates (1 kg) was mixed with the seasoning liquid (300 g) containing a rare sugar shown in Table 13, followed by heating at 120° C. for 15 minutes, thereby producing liver sashimi-like konjac. The liver sashimi-like konjac after the treatment had a pH value of 4.27, a sugar content of 8.8, and a salt content of 1.8%. A drawing created from a photograph of the appearance of the finished product with the seasoning entangled therein is shown in FIG. 12.

TABLE 13
Liver sashimi-like
Seasoning liquid recipe

| | |
|---|---|
| Soy sauce | 31.0% |
| Mirin | 9.5% |
| Sucrose | 2.6% |
| Fish sauce | 0.8% |
| Brewed vinegar | 0.6% |
| Seafood extract | 0.5% |
| Fructose glucose liquid sugar | 0.4% |
| Sea tangle extract | 0.3% |
| Brown molasses | 0.3% |
| Yeast extract | 0.2% |
| Modified starch | 0.2% |
| Sodium chloride | 5.2% |
| 50% gluconic acid | 7.0% |
| Sodium gluconate | 0.6% |
| Calcium lactate | 0.3% |
| Sodium succinate | 0.3% |
| Sodium L-ascorbate | 0.3% |
| Sodium inosinate | 0.2% |
| Shirodashi | 5.8% |
| Rare sugar-containing syrup | 19.2% |
| (Rare Sugar Sweet) | |
| Water | 14.7% |

Liver sashimi-like konjac 1 kg
Seasoning liquid above 250 g
Seasoning liquid pH: 3.56
Sugar content: 37.2%
Salt content: 6.6%
Finished pH 4.27
Sugar content 8.8%
Salt content 1.8%

### [Production of Chinese Jellyfish-Like Konjac]

Water was added to konjac powder and the mixture was mixed and stirred to form konjac paste, calcium hydroxide was added to the konjac paste, the paste was uniformly kneaded into gel, and the gel was shaped into plates of about 5 mm×1.5 mm×50-70 mm. The konjac plates (1 kg) were mixed with the seasoning (300 g) containing a rare sugar shown in Table 14, followed by heating at 120° C. for 15 minutes, thereby producing Chinese jellyfish-like konjac.

The seasoning liquid had a pH value of 3.52, a sugar content of 36.0%, and a salt content of 8.4%. The Chinese fellyfish-like konjac after the treatment had a pH value of 4.22, a sugar content of 9.4%, and a salt content of 1.9%. A drawing created from a photograph of the appearance of the finished product with the seasoning entangled therein is shown in FIG. 13.

TABLE 14
Chinese jellyfish-like konjac
Seasoning liquid recipe

| | |
|---|---|
| Soy sauce | 13.0% |
| Reduced sugar syrup | 12.0% |
| Brewed vinegar | 6.6% |
| Sesame oil | 3.0% |
| Red pepper | 0.1% |
| Spirit | 1.2% |
| Sodium glutamate | 0.2% |
| Caramel color | 0.3% |
| Spice extract | 0.1% |
| Sodium chloride | 11.0% |
| Sucrose | 5.0% |
| Red bell pepper chip | 0.2% |
| gluconic acid | 4.0% |
| Sodium gluconate | 1.5% |
| Xanthan gum | 0.4% |
| Calcium lactate | 0.4% |
| Sodium L-ascorbate | 0.3% |
| Modified starch | 0.3% |
| Sodium inosinate | 0.2% |
| Sucralose | 0.1% |
| Rare sugar-containing syrup | 11.0% |
| (Rare Sugar Sweet) | |
| Water | 29.1% |

Chinese fellyfish-like konjac 1 kg
Seasoning liquid above 300 g
Seasoning liquid pH: 3.52
Sugar content: 36.0%
Salt content: 8.4%
Finished pH 4.22
Sugar content 9.4%
Salt content 1.9%

### INDUSTRIAL APPLICABILITY

The processed konjac food or drink of the present invention exhibits a blood glucose increase suppressing effect through eating or drinking. Since the taste, texture, and the like can be varied relatively freely, the product can respond to diverse preferences and enables continual ingestion for a long period. Due to these characteristics, the present invention makes it possible to provide various processed konjac foods or drinks useful for preventing or treating diseases caused by increase of blood glucose level, in diabetics or other patients.

1-16. (canceled)

17. A processed konjac food or drink having blood glucose increase suppressing effect, comprising a konjac having a pH in the range of 2.5 to 7.4 and a rare sugar, as active ingredients.

18. The processed konjac food or drink having blood glucose increase suppressing effect according to claim 17, wherein the rare sugar is D-psicose and/or D-allose.

19. The processed konjac food or drink having blood glucose increase suppressing effect according to claim 17 or 18, wherein the rare sugar is D-psicose and/or a derivative thereof, and the derivative of D-psicose is selected from a sugar alcohol obtained by converting a ketone group in D-psicose into an alcohol group, an uronic acid obtained by oxidizing an alcohol group in D-psicose, and an amino sugar obtained by replacing an alcohol group in D-psicose with an NH2 group.

20. The processed konjac food or drink having blood glucose increase suppressing effect according to claim 17 or 18, wherein the rare sugar is a D-allose and/or a derivative thereof, and the derivative of D-allose is selected from a sugar alcohol obtained by converting an aldehyde group in D-allose into an alcohol group, an uronic acid obtained by oxidizing an alcohol group in D-allose, an amino sugar obtained by replacing an alcohol group in D-allose with an NH2 group.

21. The processed konjac food or drink having blood glucose increase suppressing effect according to any one of claim 17 or 18, wherein the konjac having a pH in the range of 2.5 to 7.4 is a fine grain konjac having a grain size of 0.1 to 3.0 mm.

22. The processed konjac food or drink having blood glucose increase suppressing effect according to claim 17 or 18, wherein the processed konjac food or drink is a smoothie-like food or drink.

23. The processed konjac food or drink having blood glucose increase suppressing effect according to claim 17 or 18, wherein the konjac having a pH in the range of 2.5 to 7.4 is a fine grain konjac having 0.1 to 3.0 mm of particle size, which is produced by mixing the grains with an acidic material in an amount at least capable of neutralizing an alkali content contained in the grains, and heat-treating the mixture.

24. The processed konjac food or drink having blood glucose increase suppressing effect according to claim 17 or 18, wherein the konjac having a pH in the range of 2.5 to 7.4 is a fine grain konjac having 0.1 to 3.0 mm of particle size, which is produced by mixing the grains with an acidic material in an amount at least capable of neutralizing an alkali content contained in the grains, and heat-treating the mixture, the acidic material contains at least one selected from a seasoning, a thickening substance, a fruit juice, a puree obtained by crushing and straining a fruit and/or a vegetable, a fruit paste, and a vegetable paste.

25. The processed konjac food or drink having blood glucose increase suppressing effect according to claim 17 or 18, wherein the konjac having a pH in the range of 2.5 to 7.4 is a fine grain konjac having 0.1 to 3.0 mm of particle size, which is produced by mixing the grains with an acidic material in an amount at least capable of neutralizing an alkali content contained in the grains, and heat-treating the mixture, the acidic material contains at least one acidulant selected form gluconic acid, citric acid, and lactic acid, for neutralizing the alkali content.

26. The processed konjac food or drink having blood glucose increase suppressing effect according to claim 17 or 18, which is intended for ingestion of the rare sugar, at a daily dose of 0.3 to 50 g/day, together with the konjac, for suppressing blood glucose increase.

27. The processed konjac food or drink having blood glucose increase suppressing effect according to claim 17 or 18, which is intended for ingestion of a daily dose of the rare sugar together with the konjac, in a form containing 40 to 95% by weight of the konjac and 0.1 to 10.0% by weight of the rare sugar, based on the whole food or drink.

28. The processed konjac food or drink having blood glucose increase suppressing effect according to claim 17 or 18, which is intended for ingestion of a daily dose of the rare sugar, in at least once a day, together with the konjac.

29. A food or drink in container, which contains the processed konjac food or drink having blood glucose increase suppressing effect as set forth in claim 17 or 18.

30. The food or drink in container, which contains the processed konjac food or drink having blood glucose increase suppressing effect as set forth in claim 17 or 18, wherein one container contains the rare sugar in an amount of 0.3 to 50 g which is an intake required for one day, together with the konjac.

31. A method for suppressing blood glucose increase, characterized by comprising a step of ingesting the processed konjac food or drink asset forth in claim 17 or 18.

32. The method for suppressing blood glucose increase, characterized by comprising a step of ingesting the processed konjac food or drink asset forth in claim 17 or 18 at every meal.
